(19) United States
(12) Patent Application Publication
(10) Pub. No.: US 2012/0146868 A1
(43) Pub. Date: Jun. 14, 2012

(54) ANTENNA SUPERSTRATE COMPOSED OF ARRANGEMENT OF CELLS WITH BROKEN PERIODICITY, ANTENNA STRUCTURE HAVING THE SAME AND MANUFACTURING METHOD THEREOF

(75) Inventor: Dong Ho Kim, Daejeon (KR)

(73) Assignee: ELECTRONICS AND TELECOMMUNICATIONS RESEARCH INSTITUTE, Daejeon (KR)

(21) Appl. No.: 13/316,496

(22) Filed: Dec. 10, 2011

(30) Foreign Application Priority Data
Dec. 10, 2010 (KR) 10-2010-0126017

(51) Int. Cl. H01Q 1/38; H01P 11/00; H01Q 9/16

(52) U.S. Cl. 343/793; 343/700 MS; 29/600

(57) ABSTRACT

Disclosed are an antenna superstrate and an antenna structure having the same. More specifically, it is possible to widen an impedance matching bandwidth and a radiation bandwidth of an antenna while maintaining a high antenna gain characteristic as it is as compared with a method of using an antenna superstrate in which cells are arranged periodically in the related art by breaking periodicity of cells arranged in the antenna superstrate.

### CROSS-REFERENCE TO RELATED APPLICATIONS

This application is based on and claims priority from Korean Patent Application No. 10-2010-0126017, filed on Dec. 10, 2010, with the Korean Intellectual Property Office, the present disclosure of which is incorporated herein in its entirety by reference.

### TECHNICAL FIELD

The present disclosure relates to an antenna superstrate and an antenna structure having the same, and more particularly, to an antenna superstrate composed of an arrangement of cells with broken periodicity and an antenna structure having the same that can increase an impedance matching bandwidth and a radiation bandwidth of an antenna while maintaining an antenna gain by breaking periodicity of the cells arranged on a superstrate of the antenna.

### BACKGROUND

In order to increase an antenna gain, a method of placing a converter between a source and an opening, such as a horn antenna and a method of placing a plurality of antennas are used.

In recent years, apart from these methods, a method for increasing the antenna gain by adopting a superstrate of the antenna while using a small number of antenna devices has been introduced. In this method, the superstrate and a ground or the superstrate and the superstrate serve as a resonator to increase the antenna gain, but an impedance matching bandwidth and a radiation bandwidth of the antenna become much narrower.

FIG. 1 is an example showing a method of configuring a superstrate generally used in order to acquire a high antenna gain. In FIG. 1, the superstrate of the antenna generally includes a plurality of cells 100 composed of conductors and a dielectric plate 100 supporting cells 100. In the general configuration of the superstrate, the same cells are uniformly placed as shown in FIG. 1. However, in such a method, the antenna gain is increased, but the impedance matching bandwidth and the radiation bandwidth become much narrower.

### SUMMARY

The present disclosure has been made in an effort to provide an antenna superstrate composed of an arrangement of cells with broken periodicity that can increase an impedance matching bandwidth and a radiation bandwidth while maintaining an antenna gain by changing an existing uniform arrangement of superstrate cells to a non-uniform arrangement in order to improve superstrate placement used to increase the antenna gain in the related art or a narrow impedance matching bandwidth and a narrow radiation bandwidth which are disadvantages of the introduced art.

The present disclosure has been made in an effort to provide an antenna structure having an antenna superstrate composed of an arrangement of cells with broken periodicity that can increase an impedance matching bandwidth and a radiation bandwidth while maintaining an antenna gain.

An exemplary embodiment of the present disclosure provides an antenna superstrate including: a dielectric plate; and a plurality of unit cells arranged on the dielectric plate in an irregular pattern.

Another exemplary embodiment of the present disclosure provides an antenna structure including an antenna; and an antenna superstrate where a plurality of unit cells are arranged in an irregular pattern.

Yet another exemplary embodiment of the present disclosure provides a manufacturing method of an antenna structure, including: providing a dielectric plate; and manufacturing an antenna superstrate by forming a plurality of unit cells on the dielectric plate in an irregular pattern.

According to the exemplary embodiments of the present disclosure, a method of breaking periodicity can widen an impedance matching bandwidth and a radiation bandwidth of an antenna while maintaining a high antenna gain characteristic as it is as compared with a method of using an antenna superstrate in which cells are arranged periodically in the related art.

In the case of the existing antenna, various modifications of a structure of a feeder antenna have been attempted for impedance matching and when the present disclosure is applied, such a process may be very simple or omitted.

Accordingly, when the present disclosure is applied, both the impedance matching bandwidth and the radiation bandwidth of the antenna can be widened as well as ensuring the high antenna gain, and as a result, a tuning process required for impedance matching is simplified.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a superstrate of an antenna generally used to acquire a high gain.

FIGS. 2A to 2C are plan views of an antenna superstrate in which shapes and arrangements of cells are variously modified according to an exemplary embodiment of the present disclosure.

FIGS. 3A to 3D are cross-sectional views of an antenna superstrate in which shapes and arrangements of cells are variously modified according to an exemplary embodiment of the present disclosure.

FIG. 4 is a cross-sectional view of an antenna superstrate in which the superstrates of FIGS. 2 and 3 are placed in multi-layers.

FIG. 5 is a cross-sectional view of an antenna structure constituted by a superstrate and an antenna according to an exemplary embodiment of the present disclosure.

FIG. 6 is a graph showing an impedance matching bandwidth of a case in which cells are uniformly arranged to have a predetermined periodicity and a case in which periodicity is broken according to an exemplary embodiment of the present disclosure.

FIG. 7 is a graph showing a gain bandwidth of a case in which cells are uniformly arranged to have a predetermined periodicity and a case in which periodicity is broken according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The present disclosure provides a method capable of increasing an impedance matching bandwidth and a radiation bandwidth while maintaining or increasing a gain of an antenna by breaking periodicity of cells constituting a superstrate of the antenna and non-uniformly arranging the cells.

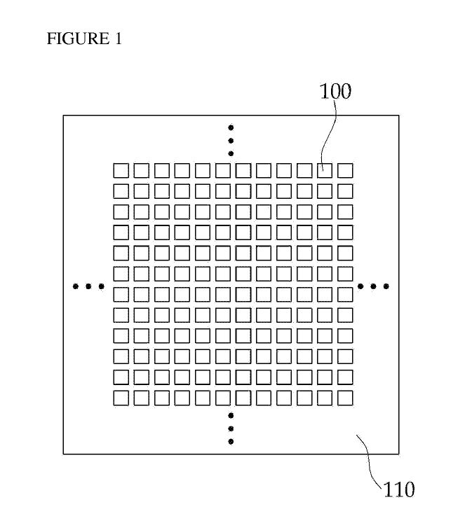

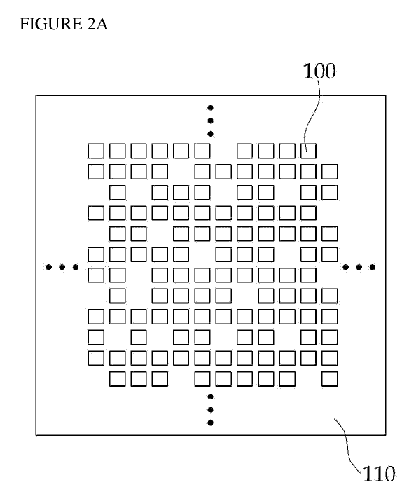

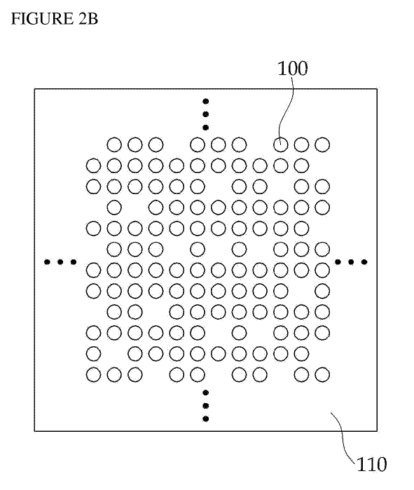

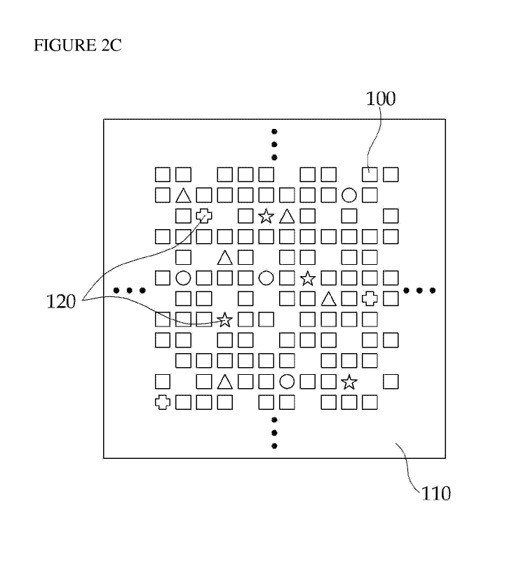

FIGS. 2A to 2C are plan views of an antenna superstrate in which shapes and arrangements of cells are variously modified according to an exemplary embodiment of the present disclosure. As specifically described in FIG. 1, the cells placed in the antenna superstrate in the related art are arranged regularly, but referring to FIG. 2A, the antenna superstrate according to the exemplary embodiment of the present disclosure has a structure in which a plurality of unit cells 10 are irregularly placed on a dielectric plate 110. Plural unit cells 100 formed on dielectric plate 110 are composed of conductors. As described above, when cells 100 are irregularly arranged on dielectric plate 110 by breaking arrangement periodicity of cells 100, both the impedance matching bandwidth and the radiation bandwidth can be increased as well as increasing the gain of the antenna, as described below.

FIG. 2B is the same as FIG. 2A in that unit cells 100 are irregularly arranged by breaking the arrangement periodicity, but shows an exemplary embodiment in which the shapes of unit cells 100 are different from the shapes of the cells of FIG. 2A. FIG. 2C shows an exemplary embodiment in which unit cells 100 and 120 have different shapes. As described above, by placing cells 100 and 120 having different shapes as well as breaking the periodicity, all of the antenna gain, the impedance matching bandwidth, and the radiation bandwidth may be increased.

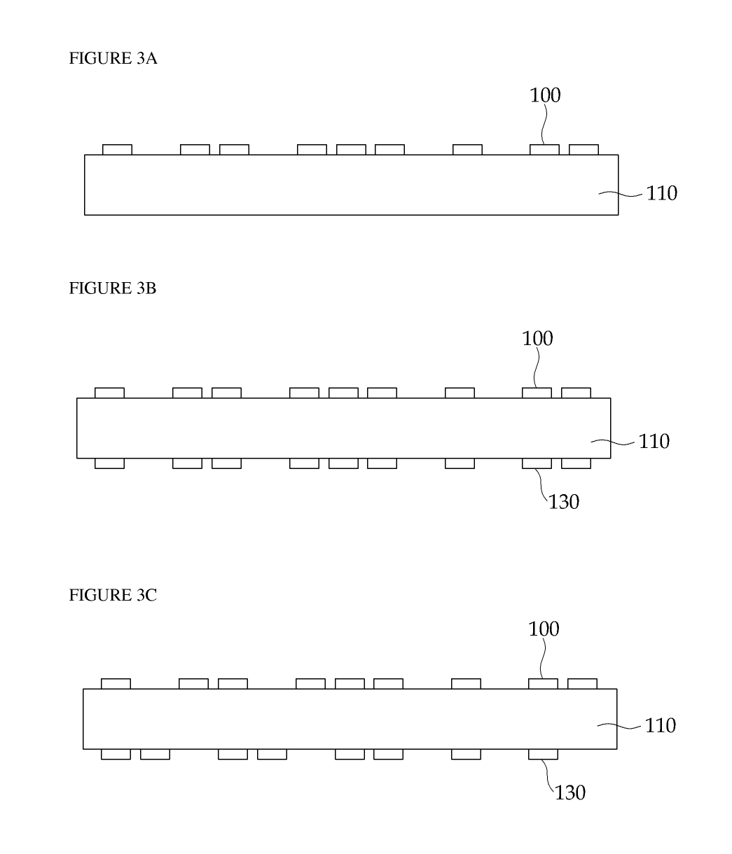

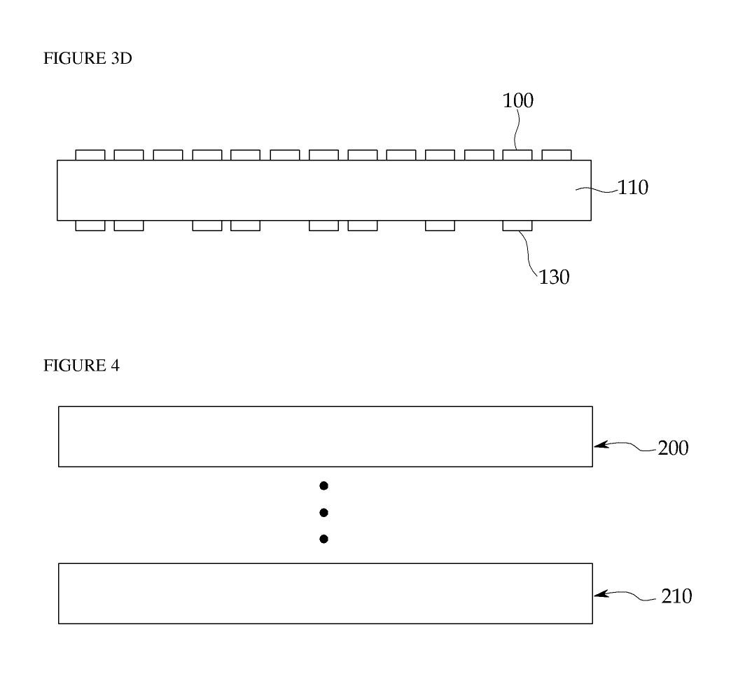

FIGS. 3A to 3D are cross-sectional views of an antenna superstrate in which shapes and arrangements of cells are variously modified according to an exemplary embodiment of the present disclosure.

That is, FIG. 3A is a cross-sectional view of an antenna superstrate composed of an arrangement of cells 100 with broken periodicity shown in FIG. 2A. Cells 100 with broken periodicity may be placed on only any one surface of dielectric plate 110 as shown in FIG. 3A or placed on both surfaces of dielectric plate 110 as shown in FIGS. 3B to 3D.

When the cells are placed on both surfaces of dielectric plate 110, cells 100 and 130 may be placed on both surfaces in the same pattern and cells 100 and 130 may be placed in different patterns as shown in FIGS. 3C and 3D. As shown in FIG. 3D, cells 100 may be periodically arranged on one surface of dielectric plate 110 and cells 130 may be irregularly arranged on the other surface.

That is, the methods of FIGS. 3B to 3D are an exemplary embodiment in which various arrangement methods of the cells with broken periodicity are applied to the top surface and the bottom surface of dielectric plate 110. In this case, in the arrangement method of FIGS. 3A to 3D, cells 100 and 120 having different shapes may also be arranged as shown in FIG. 2C.

FIG. 4 is a cross-sectional view of a multi-layered antenna superstrate in which the antenna superstrates of FIGS. 2 and 3 are placed in multi-layers. Referring to FIG. 4, the antenna superstrate specifically described in FIGS. 2 and 3 may be placed in multi-layers. In antenna superstrates 200 and 210 shown in FIG. 4, the arrangement of the cells is omitted, but antenna superstrates 200 and 210 may include all the exemplary embodiments for the arrangement and shape of each cell shown in FIGS. 2 and 3.

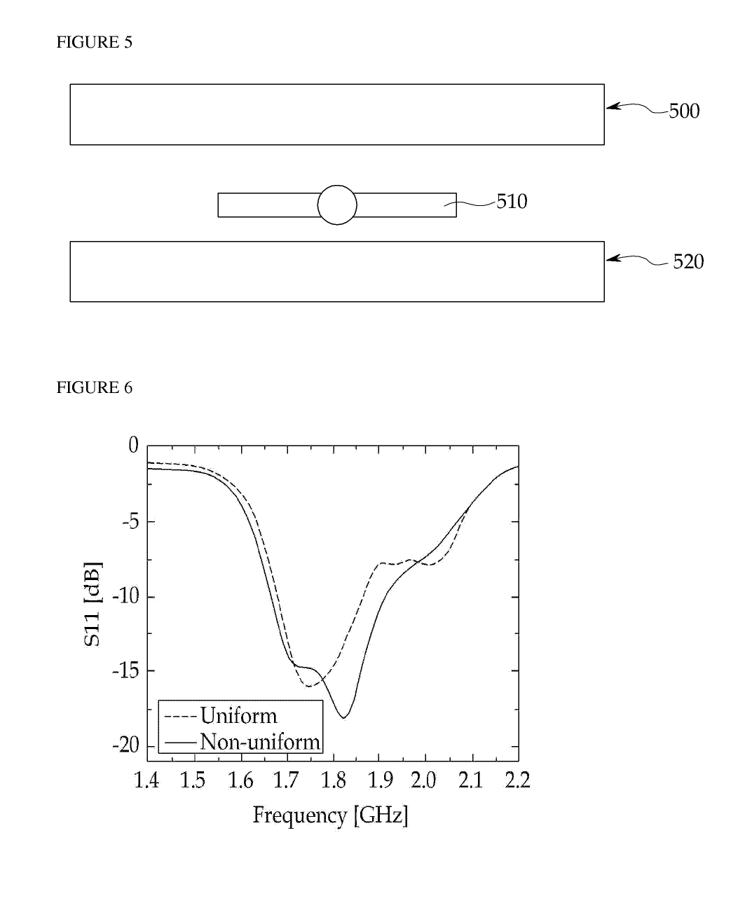

FIG. 5 is a cross-sectional view of an antenna structure constituted by a superstrate and an antenna according to an exemplary embodiment of the present disclosure.

In FIG. 5, both reference numeral 500 and reference numeral 520 may be constituted by the superstrates and as another method, reference numerals 500 and 520 may also be constituted by the superstrate and a general earth, respectively. In this case, antenna 510 may be positioned between reference numeral 500 and reference numeral 520.

In the antenna structure according to the exemplary embodiment of the present disclosure, reference numerals 500 and 520 are not particularly required at the same time, but as necessary, reference numerals 500 or 520 may be omitted.

Various cell arrangement methods, the periodicity breaking method, and the superstrate placing method shown in FIGS. 2, 3, and 4 may be all applied to the antenna structure shown in FIG. 5.

Antenna 510 may be positioned between reference numerals 500 and 520 as shown in FIG. 5 and as necessary, attached to reference numeral 500 or 520 or designed directly in reference numeral 500 or 520.

For example, a dipole antenna may be positioned between reference numerals 500 and 520 and a patch antenna may be attached directly to reference numeral 500 or 520.

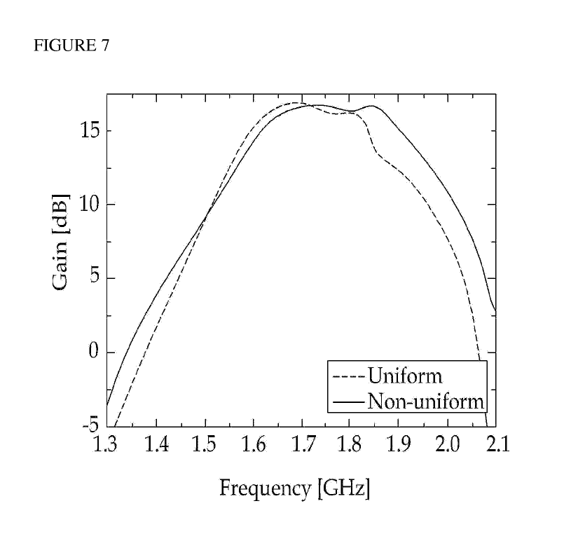

FIGS. 6 and 7 are graphs showing an impedance matching bandwidth and a gain bandwidth of a case in which cells are uniformly arranged to have a predetermined periodicity (uniform) and a case in which periodicity is broken according to an exemplary embodiment of the present disclosure (non-uniform).

As shown in FIG. 6, the impedance matching bandwidth is approximately 10% based on −10 dB when uniform cells are arranged and approximately 14% when the superstrate composed of the cells with broken periodicity is used according to the exemplary embodiment of the present disclosure. Accordingly, through the method according to the exemplary embodiment of the present disclosure, the impedance matching bandwidth may be increased by approximately 4%.

As shown in FIG. 7, a 3 DB bandwidth of a gain in the case of using the superstrate with broken periodicity according to the exemplary embodiment of the present disclosure is approximately 3.5% larger than that in the case of not using the superstrate.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An antenna superstrate composed of an arrangement of cells with broken periodicity, comprising:
a dielectric plate; and
a plurality of unit cells arranged on the dielectric plate in an irregular pattern.

2. The antenna superstrate of claim 1, wherein in the plurality of unit cells, at least one unit cell has a different shape from another unit cell.

3. The antenna superstrate of claim 1, wherein in the dielectric plate, a plurality of unit cells are additionally placed on an opposite surface to the surface where the plurality of unit cells are placed.

4. The antenna superstrate of claim 3, wherein in the dielectric plate, the plurality of unit cells placed on different surfaces are formed in the same pattern as each other.

5. The antenna superstrate of claim 3, wherein in the dielectric plate, the plurality of unit cells placed on different surfaces are formed in different patterns from each other.

6. An antenna structure, comprising:
an antenna; and
an antenna superstrate where a plurality of unit cells are arranged in an irregular pattern.

7. The antenna structure of claim 6, wherein the antenna superstrate is placed in the upper part or lower part of the antenna.

8. The antenna structure of claim 7, wherein the antenna superstrates are overlapped with each other to be placed in multi-layers.

9. The antenna structure of claim 6, wherein when the antenna is a dipole antenna, the antenna superstrate is installed spaced apart from the antenna by a predetermined distance.

10. The antenna structure of claim 6, wherein when the antenna is a patch antenna, the antenna superstrate is installed to be attached directly to the antenna.

11. The antenna structure of claim 6, wherein when the antenna is a pattern antenna, the antenna is patterned in the antenna superstrate.

12. The antenna structure of claim 6, wherein in the plurality of unit cells, at least one unit cell has a different shape from another unit cell.

13. The antenna structure of claim 6, wherein the antenna superstrate has a structure in which the plurality of unit cells placed on both surfaces of a dielectric plate are arranged in the same pattern as each other.

14. The antenna structure of claim 6, wherein the antenna superstrate has a structure in which the plurality of unit cells placed on both surfaces of a dielectric plate are arranged in different patterns from each other.

15. A manufacturing method of an antenna structure, comprising:
providing a dielectric plate; and
manufacturing an antenna superstrate by forming a plurality of unit cells on the dielectric plate in an irregular pattern.

16. The method of claim 15, further comprising placing the antenna superstrate in the upper part or lower part of the antenna.

17. The method of claim 16, further comprising overlapping the antenna superstrates to place the antenna superstrates in multi-layers.

18. The method of claim 15, wherein in the manufacturing of the antenna superstrate, in the dielectric plate, a plurality of unit cells are placed on an opposite surface to the surface where the plurality of unit cells are placed.
